(19) United States
(12) Patent Application Publication
(10) Pub. No.: US 2026/0154529 A1
(43) Pub. Date: Jun. 4, 2026

(54) METHOD AND SYSTEM FOR DISTRIBUTED DECISION-MAKING IN MULTI- ROLE LARGE LANGUAGE MODELS ARCHITECTURE

(71) Applicant: Quantiphi, Inc, Marlborough, MA (US)

(72) Inventors: Dagnachew Birru, Marlborough, MA (US); Tehemton K Khairabadi, Mumbai (IN); Vishal Pagidipally, Toronto (CA); Muneeswaran I, Mumbai (IN); Nim Lhamu Sherpa, Mumbai (IN)

(73) Assignee: Quantiphi, Inc, Marlborough, MA (US)

(21) Appl. No.: 18/969,253

(22) Filed: Dec. 4, 2024

(51) Int. Cl. G06N 3/045

(52) U.S. Cl. CPC G06N 3/045

(57) ABSTRACT

Disclosed is method for distributed decision-making in multi-role large language models (LLMs) architecture (mLLMa). Method comprises: receiving user query for initiating conversation between user and mLLMa; using graphical representation (GR) for identifying role(s) associated with user query, wherein role(s) is based on context thereof; assigning relevance score to each role; dynamically passing role(s), to mLLMa; generating role-specific prompt for role assumed by LLM; generating, by each LLM, role-specific response (RR) corresponding to role-specific prompt for each role and context; presenting RR from each LLM to peer LLMs; conducting polling process among LLMs for ranking RR therefrom; aggregating rankings from polling process to determine final ranking of RR for each LLM; selecting RR having highest final ranking as an action-inducing response (AR), and transmitting AR to user for providing user action; and updating GR based on AR and user action.

### FIELD OF TECHNOLOGY

The present disclosure relates to a general field of the optimization of large language models (LLMs) to a flow of conversation. Specifically, the present disclosure relates to a method and a system for distributed decision-making in a multi-role large language models (LLMs) architecture.

### BACKGROUND

In recent years, the exponential development in Artificial Intelligence (AI) and large language models (LLMs) has significantly contributed to the advancement in various related fields such as natural language processing, virtual assistants, dialogue generation, automated customer service and knowledge graph utilization. The aforementioned advancement has enabled machines to comprehend and generate human-like text, leading to improved conversational experiences. However, as the complexity of the conversational tasks increase, a technical challenge concerning efficient management of multiple roles and knowledge domains in a dynamic conversation without overwhelming the language model or compromising the relevance and accuracy of its responses arises. The challenge becomes even more pronounced when the conversations span multiple turns, requiring continuous adaptation to changing contexts, entities, and user inputs.

Existing solutions to address the problem of efficiently managing multiple roles and knowledge domain in the dynamic conversation by employing static role-based or domain-based systems for response generation. For example, some approaches utilize predefined rules or domain-specific classifiers to determine which roles or areas of expertise should be activated during a conversation. Moreover, the existing solutions also incorporate graph-based knowledge retrieval solutions to provide relevant background information, aiding in generating more informed responses. However, the existing solutions are often rigid and unable to handle evolving conversational contexts effectively. Static role assignments, for instance, may lead to unnecessary complexity, as irrelevant roles are still engaged, leading to longer processing times and less accurate responses.

Despite these efforts, the existing solutions still suffer from several limitations. The existing solutions lacks the ability to dynamically adapt role selection and domain knowledge to the specific context of the conversation. Moreover, the existing solutions tend to overburden the LLM with excessive or outdated roles, which dilutes the quality of generated responses.

Therefore, in the light of the foregoing discussion, there exists a need to overcome the aforementioned drawbacks.

### BRIEF SUMMARY OF THE DISCLOSURE

The present disclosure provides a method and a system to ensure that distributed decision-making in a multi-role large language models (LLMs) architecture improves conversation quality and accuracy by dynamically assigning roles based on user queries. The present disclosure seeks to provide a solution to the existing problem of how to simplify and automate a process of the optimization of large language models (LLMs) to a flow of conversation. The aim of the present disclosure is to provide a solution that overcomes at least partially the problems encountered in the prior art and provide an improved system and method for distributed decision-making in a multi-role large language models (LLMs) architecture. The aim of the present disclosure is achieved by a system and a method for distributed decision-making in a multi-role large language models (LLMs) architecture using at least one neural network for identifying at least one role to enhance conversation between a user and the LLMs by dynamically assigning roles.

In one aspect, the present disclosure provides a method for distributed decision-making in a multi-role large language models (LLMs) architecture. The method comprises receiving a user query for initiating a conversation between a user and the multi-role LLMs architecture. Moreover, the method comprises using a graph representation for identifying a plurality of roles, from a role pool, associated with the user query, wherein the plurality of roles is based on a context of the user query. Furthermore, the method comprises assigning a relevance score to each of the plurality of roles, wherein the relevance score is assigned based on the context of the user query. Furthermore, the method comprises dynamically assigning at least one role, from amongst the plurality of roles, to the multi-role LLMs architecture. Furthermore, the method comprises generating a role-specific prompt for each role assumed by each LLM from amongst the multi-role LLMs architecture. Furthermore, the method comprises generating, by each LLM, a role-specific response corresponding to the role-specific prompt for each role and the context of the user query. Furthermore, the method comprises presenting the role-specific response from each LLM to peer LLMs. Furthermore, the method comprises conducting a polling process among the LLMs for ranking the role-specific responses from the LLMs, wherein a given LLM is configured to give a ranking to the role-specific response from the peer LLMs except the role-specific response of said given LLM. Furthermore, the method comprises aggregating the rankings based on the polling process among the LLMs and the relevance score of each of the plurality of roles to determine a final ranking of the role-specific response for each LLM. Furthermore, the method comprises selecting the role-specific response having a highest final ranking, from amongst the final ranking of the role-specific response for each LLM, as an action-inducing response, and transmitting the selected action-inducing response to the user for providing a user action. Furthermore, the method comprises updating the graph representation based on the action-inducing response and the user action, wherein the updating of the graph representation comprises removing the at least one role having lowest final ranking in a set of previous conversations.

Beneficially, the embodiments of the present disclosure provide a simplified, efficient and automated method that ensures handling complex, multi-role conversations. Moreover, the method effectively handles real-time changes in user input, while continuously refining the decision-making process. The use of neural networks for role identification and relevance scoring ensures that the method is both dynamic and context-aware, responding in real-time to the specific needs of the conversation. Moreover, the role-specific prompt and response generation ensures that each LLM works within its domain of expertise, providing accurate and nuanced responses, while the polling process distributes decision-making across multiple LLMs, preventing biases from any single model. Furthermore, continuous updating of roles ensures that the method becomes more efficient and intelligent with each interaction, learning from previous conversations to enhance future ones. The roles that are consistently ranked lower are removed, and new, more relevant roles are introduced based on past conversations. This continuous learning mechanism ensures that the system evolves over time, becoming more adept at selecting the most appropriate roles and responses in future interactions.

In another aspect, provides a system for distributed decision-making in a multi-role large language models (LLMs) architecture. The system comprises a processor communicably coupled to a user device. The processor is configured to receive a user query for initiating a conversation between a user and the multi-role LLMs architecture. Moreover, the processor is configured to use a graph representation for identifying a plurality of roles, from a role pool, associated with the user query, wherein the plurality of roles is based on a context of the user query. Furthermore, the processor is configured to assign a relevance score to each of the plurality of roles, wherein the relevance score is assigned based on the context of the user query. Furthermore, the processor is configured to dynamically assign the at least one role, from amongst the plurality of roles, to the multi-role LLMs architecture. Furthermore, the processor is configured to generate a role-specific prompt for each role assumed by each LLM from amongst the multi-role LLMs architecture. Furthermore, the processor is configured to generate, by each LLM, a role-specific response corresponding to the role-specific prompt for each role and the context of the user query. Furthermore, the processor is configured to present the role-specific response from each LLM to peer LLMs. Furthermore, the processor is configured to conduct a polling process among the LLMs for ranking the role-specific responses from the LLMs, wherein a given LLM is configured to give a ranking to the role-specific response from the peer LLMs except the role-specific response of said given LLM. Furthermore, the processor is configured to aggregate the rankings based on the polling process among the LLMs and the relevance score of each of the plurality of roles to determine a final ranking of the role-specific response for each LLM. Furthermore, the processor is configured to select the role-specific response having a highest final ranking, from amongst the final ranking of the role-specific response for each LLM, as an action-inducing response, and transmitting the selected action-inducing response to the user for providing a user action. Furthermore, the processor is configured to update the graph representation based on the action-inducing response and the user action, wherein the updating of the graph representation comprises removing the at least one role having lowest final ranking in a set of previous conversations.

The system achieves all the advantages and technical effects of the method of the present disclosure. Herein, the system enables the processor to improve conversation quality and accuracy by dynamically assigning roles based on user queries.

In yet another aspect, the present disclosure provides a non-transitory computer-readable storage medium having computer-readable instructions stored thereon, the computer-readable instructions being executable by a processor to execute the aforementioned method.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a flowchart of a method for distributed decision-making in a multi-role large language models (LLMs) architecture, in accordance with an embodiment of the present disclosure;

FIG. 2 is a flowchart depicting of an exemplary scenario of a distributed decision-making in a multi-role large language models (LLMs) architecture, in accordance with an embodiment of the present disclosure; and

FIG. 3 is a schematic illustration of a system for distributed decision-making in a multi-role large language models (LLMs) architecture, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

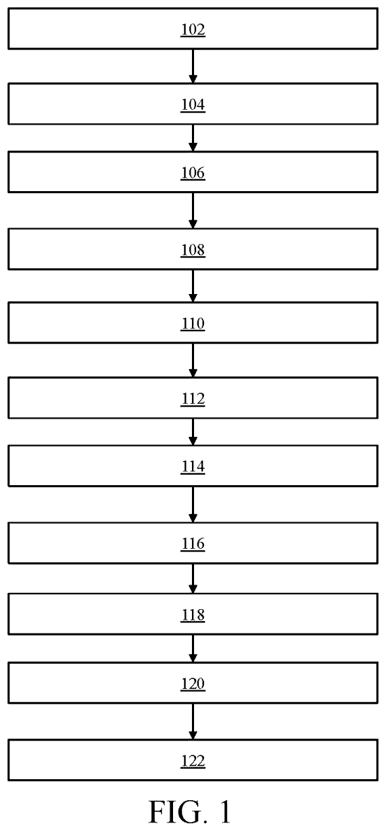

FIG. 1 is a flowchart 100 of a method for distributed decision-making in a multi-role large language models (LLMs) architecture, in accordance with an embodiment of the present disclosure. The method comprises steps from 102 to 122.

Throughout the present disclosure, the term “distributed decision-making” refers to a decision-making process where multiple LLMs, each with a specific role and expertise, collaborate and contribute to decision-making tasks. Typically, the distributed decision-making is decentralised and shared among multiple LLMs instead of relying on a single central authority. Throughout the present disclosure, the term “multi-role large language models (LLMs) architecture” refers to an architecture where multiple LLMs are designed to perform distinct roles or functions within a large framework. Typically, the multi-role LLMs architecture employs multiple large language models (LLMs) with distinct roles assigned based on the topics being discussed, allowing for more relevant and grounded responses. Beneficially, the distributed decision-making is able to handle complex, multi-faceted queries that require expertise across different domains. Moreover, the multi-role LLMs architecture ensures that the distributed decision-making draws on a diverse set of skills and perspectives. This reduces the likelihood of errors in complex queries where a single model may not have sufficient context or expertise. Furthermore, the multi-role LLMs architecture enhances efficiency, accuracy, and contextual relevance of the distributed decision-making.

At step 102, a user query is received for initiating a conversation between a user and the multi-role LLMs architecture. Throughout the present disclosure, the term “user” refers to an individual, entity, or an organization that interacts with the multi-role LLMs architecture by submitting a query to initiate a conversation. Notably, optionally, the user can be a human individual seeking information or assistance, an automated system generating queries for specific tasks, or an organization interacting with the multi-role LLMs architecture to solve domain-specific problems. Throughout the present disclosure, the term “user query” refers to a request or input made by a user to obtain specific information or perform a particular action. Typically, the user query is provided in the form of a question, command or request for information. Notably, the user query can be provided in natural language (text or spoken) or in machine-interpretable formats. The user query defines the subject, problem or request that needs to be addressed by the LLMs. The term “conversation” refers to an interactive exchange of queries or dialogues between the user and the multi-role LLMs architecture, typically involving multiple turns. Moreover, the user query serves as the starting point for the conversation between the user and the multi-role LLMs architecture. Furthermore, the receiving of the user query activates the multi-role LLMs architecture to initiate the conversation between the user and the distributed decision-making framework within the multi-role LLMs architecture and determines scope of the conversation based on the user query. Furthermore, once the user query is received, the user query undergoes initial processing to extract the initial information (such as keywords, context, subject and the like).

At step 104, a graph representation is used for identifying plurality of roles, from a role pool, associated with the user query, wherein the plurality of roles is based on a context of the user query. Throughout the present disclosure, the term “graph representation” refers to a structured, interconnected model used to represent data in the form of nodes and edges that capture relationships between entities. Optionally, the graph representation can be graphical neural network, knowledge graph and the like graph representation. Notably, the graph representation comprises of graph classification network and graph traversal network. Moreover, the graph classification network is a pre-trained graph network with sub-graph role probabilities. It will be appreciated that, the term “neural network” refers to a computational artificial intelligence (AI) model inspired by the structure and functioning of the human brain, which consists of interconnected layers of artificial neurons (also known as nodes) that process and transmit information. Notably, each layer of the neural network processes the user query to recognize patterns and make predictions, classifications, or decisions.

Throughout the present disclosure, the term “role” refers to a special functional responsibility or expertise that is dynamically assigned to different large language models (LLMs). Notably, the plurality of roles is identified based on the context of the user query in order to guide the responses of the multi-role large language models (LLMs) architecture. The plurality of roles is based on the context of the user. For example, if the user query is related to medical domain, then the plurality of roles can be human roles. For example, in case of medicine, the plurality of roles can be Cardiologist, Neurologist, Internal Medicine, Rheumatologist, and the like. The term “role pool” refers to a predefined set or collection of functional roles present in the graph representation that the multi-role LLMs architecture can dynamically select therefrom. The term “context” refers to the surrounding information or circumstances derived from the user query that provides meaning and relevance to a particular situation or concept. Notably, the multi-role LLMs architecture analyses the context of the user query and selects the plurality of roles from the role pool to address the user's need.

It will be appreciated that Graph Retrieval-Augmented Generation (RAG) enhances the decision-making process of the multi-role large LLMs architecture. The graph RAG retrieves context from the graph representation based on the user query or ongoing conversation and guides the LLMs in decision-making by leveraging structured relationships in the graph representation. Moreover, the graph RAG adds contextual understanding by using the relationships between the different entities and domain-specific knowledge embedded in the graph representation, which in turn helps the LLMs perform tasks like role selection, prompt generation, and voting. The graph classification network analyses the user query to identify which roles (from a pool of predefined roles) are relevant to the query. Each role represents a different task or domain of expertise that an LLM (Large Language Model) specializes in. The graph classification network can interpret what the user is asking and match it with the most suitable role(s) based on pre-trained knowledge about the relationships between different types of queries and roles. For example, if a user query is related to healthcare, the neural network might identify roles like “oncology”, “gastrointestinal” or “cancer” based on the context of the query. If the query relates to finance, roles such as “financial analyst” or “investment advisor” could be identified. Beneficially, the at least one neural network's role identification improves precision and relevance of responses by ensuring that the selected roles align with the specific query context.

In an implementation, the method further comprises leveraging historical data for generating the graph representation. Herein, the term “historical data” refers to a previously gathered or stored information from past interactions, conversations, decisions, roles assumed by the LLMs or other relevant activities. For example, the historical data in medical domain can be patient history of past visits, test results, prescriptions, diagnoses and the like. Notably, the historical data is used to enhance the generation and refinement of the graph representation. Moreover, use of the historical data ensures that the graph representation generated reflects patterns and trends from past interactions, leading to more relevant and precise role identification and response generation. Furthermore, when a user query is received, the multi-role LLMs architecture refers to stored information from prior conversations and decisions to structure the graph representation, identifying roles and relationships between the plurality of nodes that have proven useful or relevant in similar past contexts. A technical effect of leveraging the historical data is that the multi-role LLMs architecture can more efficiently assign relevant roles, eliminating the need for re-learning from scratch in every new conversation. Additionally, the historical data and the user conversation refine the graph generation process.

In an implementation, the method further comprises generating the graph representation based on the conversation between the user and the multi-role LLMs architecture, wherein the graph representation comprises a plurality of nodes and links between the plurality of nodes; and classifying one or more sub-graphs within the graph representation to identify the plurality of roles relevant to the context of the user query. Herein, the term “nodes” refers to discrete points or entities in the graph representation. Notably, the plurality of nodes in the graph representation represents domain specific entities such as diseases, locations, variants, chemicals, and the like. Herein, the term “links” refers to connections or relationships between the plurality of nodes that enables communication, data transfer, or interaction between the plurality of nodes. Moreover, the plurality of nodes and links between the plurality of nodes generates the graph representation to show the structure of the conversation between the user and the multi-role LLMs architecture.

Herein, the term “sub-graphs” refers to smaller, distinct, or interconnected segments that are part of the graph classification network in the graph representation. Typically, the one or more sub-graphs such as (neurology, dermatology, gastroenterology, and the like) consist of a subset of the plurality of nodes and links from the graph representation. Notably, the one or more sub-graphs within the graph representation represents the plurality of roles that are more closely linked to the context of the user query. Moreover, graph traversal network is employed to classify or isolate the one or more sub-graphs within the graph representation. This facilitates identification and analysis of specific sections of the conversation that are related to the user query. Furthermore, classification of the one or more sub-graphs within the graph representation facilitates the identification of the plurality of roles most relevant to the context of the user query. For example, if the user query is related to the stomach pain, then the plurality of sub-graphs that shows gastroenterology and the plurality of roles related to the gastroenterology is identified. A technical effect of converting the conversation into the graph representation and classifying the sub-graphs is to generate more contextually appropriate and precise role-specific responses. Additionally, the method enables the multi-role LLMs architecture to handle complex conversations with numerous roles and entities by breaking them into manageable sub-graphs, enhancing scalability for larger, multi-domain interactions.

In an implementation, the role pool consists of plurality of potential specialties represented by the plurality of nodes in the traversal network, wherein the plurality of potential specialties is selected based on the relevance score. Herein, the term “potential specialties” refers to specific areas of expertise, knowledge, or focus that each role in the role pool can potentially represent within the multi-role LLMs architecture. Typically, the potential specialties are various domains or skill sets (for example, legal, technical, financial, medical and the like) that each role in the multi-role LLM architecture can assume, based on the context of the user query. Herein, the term “traversal network” refers to a graphical network in the graph representation composed of plurality of nodes and edges. Notably, the traversal network allows for the exploration of how different specialties relate to each other and to the user query context. The traversal network essential for efficiently navigating through potential specialties and selecting the most relevant ones for a given user query. Furthermore, each node in the traversal network represents a specific potential speciality and the multi-role LLMs architecture navigates the traversal network to identify the most relevant nodes (i.e., specialties) based on the user query's context. Furthermore, the relevance score, assigned to each potential specialty, determines which specialties are selected to form the roles for the task at hand. Only the specialties with a score higher than the predetermined threshold are considered relevant and are dynamically assigned to the multi-role LLM architecture. A technical effect is of employing the traversal network, is that the multi-role LLMs architecture enhances the accuracy of selecting relevant specialties, ensuring that the conversation is guided by the most appropriate roles based on the user's needs.

In an implementation, the method further comprises calculating a cosine distance between the plurality of nodes of the graph representation of the user. Herein, the term “cosine distance” refers to a mathematical measure that is used to determine similarity between the plurality of nodes of the graph representation of the user. Notably, the cosine distance used to measure how closely related two nodes amongst the plurality of nodes are by calculating the cosine distance between their respective vectors. For example, the user describing stomachache, the cosine distance given to nephrology, hepatology and gastroenterology will be more compared to specialties like rheumatology. The value of the cosine distance ranges from −1 (completely opposite) to 1 (completely similar), with 0 indicating orthogonality (no relation). Moreover, the cosine distance helps in quantifying the similarity between plurality of roles or entities within the graph representation. A technical effect of calculating the cosine distance between the plurality of nodes is to identify which roles or entities are most similar to each other, helping to refine the role selection and improves the accuracy of responses.

In an implementation, the method further comprises calculating an n-hop distance between one or more new nodes and the plurality of nodes, and wherein the n-hop distance for the one or more new nodes are averaged over the plurality of nodes to determine a traversal network score. Herein, the term “new nodes” refers to recently introduced or added nodes in the graph representation, which have not been previously part of the multi-role LLMs architecture. Notably, the one or more new nodes are different from the plurality of nodes that already exist in the graph representation and are newly connected to the graph representation based on the evolving context such as new roles introduced during the conversation with the user.

Herein, the term “n-hop distance” refers to a measure of how far apart two nodes are in terms of the number of edges or steps in the graph traversal network of the graph representation. Notably, the n-hop distance is calculated between the one or more new nodes and each node amongst the plurality of nodes. The n-hop distance is measured from each node in the sub-graph to the centre of the historical graph. Herein, the n-hop distance is measured between the corresponding plurality of nodes of conversation graph in the main domain Knowledge graph and the roles/specialties are identified in the graph representation. For example, in a graph of headache (node1) and ibuprofen (a known drug) (node2), the n-hop distance of the headache node in the domain knowledge graph is computed to the plurality of roles in the domain knowledge graph and record the n-hop distance. Subsequently, if one or more new nodes (node3) are added to the graph representation, the distance of the one or more new nodes to each specialty is also computed and every time the average distance of the said nodes to the corresponding roles is used to decide the top roles regarding the conversation knowledge graph. The variable “n” represents the number of hops, where 1-hop means the two nodes are directly connected, 2-hops means there is one intermediate node between them, and so on.

Furthermore, the purpose of calculating the n-hop distance is to understand how connected the one or more new nodes are to the plurality of nodes. It will be appreciated that the n-hop distance helps to determine the relevance of one or more new nodes by measuring how closely they are integrated with the existing nodes that represent important roles in the user query. For example, the one or more new nodes in the graph representation is Cisplatin. Now the n-hop distance can either be calculated or approximated with every specialty node from the node representing Cisplatin in the graph representation. Subsequently, observed that the n-hop distance between the Cisplatin and Oncology might be 2 and between the Cisplatin and Neurology might be 7.

Herein, the term “traversal network score” refers to a calculated network score representing the average proximity or relationship between the one or more new nodes and the plurality of nodes in the graph representation. Notably, the traversal network score is determined by averaging the n-hop distance of the one or more new nodes over the plurality of nodes. Moreover, the traversal network score helps to evaluate the relevance of the one or more new nodes based on how close they are to the plurality of nodes of the graph representation. A technical effect of calculating the n-hop distance is that allows the multi-role LLMs architecture to quickly determine how well the one or more new nodes fit into the existing graph representation that ensures that relevant nodes are incorporated into decision-making processes. Additionally, the traversal network score ensures that the relevance of the one or more new nodes is assessed based on their proximity to the plurality of nodes in the graph representation.

At step 106, a relevance score is assigned to each of the plurality of roles, wherein the relevance score is assigned based on the context of the user query. Throughout the present disclosure, the term “relevance score” refers to a numerical value that indicates the degree of relevance or importance of each of the at least one role within the given context. Notably, the relevance score reflects that how closely the at least one role aligns with the context of the user query. Beneficially, the score is crucial for determining which roles are most appropriate for generating responses based on the user query. Moreover, the relevance score avoids unnecessary processing of the at least one role that is irrelevant. Furthermore, the formula to calculate the relevance score can depend on a normalized initial score coming from the graph classification network and graph traversal network in the graph representation, multiplied by a decay factor that reduces the relevance score for the plurality of roles that have not subsequently been captured as well. Additionally, the relevance score depends upon the n-hop distance coming from graph traversal network. The relevance score acts as a recency memory, emphasizing the plurality of roles that are consistently identified from the graph representation described and reducing the roles that are not selected. Furthermore, the relevance score ensures a higher quality and more context-aware response from the multi-role LLMs architecture. The role pool consists of potential entities with relevance scores calculated based on recency and decay factors. The relevance score is determined by multiplying a normalized initial score with a decay factor, which reduces the score for roles not captured subsequently. The relevance score is updated using a formula that includes the decay factor, and the role confidence score of the graph classification network identified in the current turn by the graph representation.

In an implementation, the at least one role, from amongst the plurality of roles, having a relevance score higher than a predetermined relevance score threshold, is dynamically assigned to the multi-role LLMs architecture. Herein, the term “predetermined relevance score threshold” refers to a predefined numerical threshold value that serves as a cut-off or benchmark to determine whether the at least one role is sufficiently relevant to be forwarded to the multi-role LLMs architecture for further processing. Notably, the predetermined relevance score threshold is established through configuration, machine learning models or expert-defined parameters. Optionally, it will be appreciated that the predetermined relevance score threshold lies in the range of 0.2 to 0.6. The predetermined relevance score threshold is set based on expected performance, system requirements, or specific heuristics. Moreover, the relevance score is generated on the role's contextual significance. For example, if the score for a role exceeds the predetermined relevance score threshold of 0.4, it is considered relevant enough to be passed to the multi-role LLMs architecture for further action; otherwise, it is discarded. In this regard, the phrase “at least one role” refers to at least three roles from amongst the plurality of roles, having the relevance score higher than the predetermined relevance score threshold, is dynamically assigned to the multi-role LLMs architecture. Optionally, if the number of at least one role is less than three roles then the predetermined relevance score threshold can be bypassed to ensure that the at least three roles are dynamically assigned to the multi-role LLMs architecture for further processing. A technical effect of excluding the roles below the predetermined relevance score threshold, the multi-role LLMs architecture avoids unnecessary computations, leading to faster processing times and reduced resource consumption.

At step 108, the at least one role from amongst a plurality of roles, is dynamically assign to the multi-role LLMs architecture. Throughout the present disclosure, the term “dynamically assigning” refers to the process of automatically and continuously assigning the identified roles that meets certain criteria to the multi-role LLMs architecture, in real-time or near-real-time, based on the evolving context of the conversation. Notably, the at least one role, such as ten or more roles, from amongst the plurality of roles, is not statically predetermined but are instead selected and assigned to the multi-role LLMs architecture based on the relevance score. It will be appreciated that that the dynamic assigning of roles is based on knowledge graph (graph traversal network and Graph Retrieval-Augmented Generation (RAG)). Instead of overloading the multi-role LLMs architecture with irrelevant or low-importance roles, the method focuses only on roles that are likely to contribute valuable responses. Furthermore, the method first evaluates each identified role form the role pool by assigning the relevance score based on its importance to the user query. The assigned relevance score of each of the at least one role is compared to the predetermined relevance score threshold. If the at least one role's relevance score is higher than the predetermined relevance score threshold, it is considered relevant and passed.

At step 110, a role-specific prompt is generated for each role assumed by each LLM from amongst the multi-role LLMs architecture. Throughout the present disclosure, the term “role-specific prompt” refers to a customized instruction or query that is generated specifically for a particular role within the multi-role LLMs architecture. Notably, each of the at least one role is associated with a specific function or expertise (for example, drugs, diseases, chemicals, genes, locations, and the like) and the prompt is tailored to the said role's domain. Moreover, the purpose of the role-specific prompt is to engage the LLM in generating a response that is relevant to the role's area of knowledge and the context of the user's query.

The term “large Language Model” refers to a type of artificial intelligence (AI) model that is designed to understand and generate human-like text based on given vast amount of training prompts or queries. Typically, the Large Language Model (LLM) is based on deep learning. Notably, the LLMs are trained on diverse datasets and can generate responses to natural language queries, carry out conversations, translate text, summarize information, and the like. Moreover, each LLM from amongst the multi-role LLMs architecture is designated a specific role, based on the user's query and the context. The generated role-specific prompt ensures that each LLM from amongst the multi-role LLMs architecture delivers outputs aligned with its expertise, contributing to more structured, insightful, and relevant decision-making.

At step 112, by each LLM, a role-specific response is generated corresponding to the role-specific prompt for each role and the context of the user query. Throughout the present disclosure, the term “role-specific response” refers to a response or an output generated by each LLM within the multi-role LLMs architecture, based on the corresponding role-specific prompt for each role. Notably, the role-specific response directly corresponds to the role-specific prompt, reflecting the context of the user query that provides the necessary information to generate a relevant and accurate response. Moreover, the purpose of generating the role-specific response is to break down a complex user query into multiple sub-tasks or perspective. Each LLM contributes insights, suggestions, or actions from the viewpoint of its role in the multi-role LLMs architecture. The generation of the role-specific response corresponding to the role-specific prompt for each role ensures that the multi-role LLMs architecture leverages multiple areas of expertise, improving decision-making and user satisfaction. For example, in a healthcare query, one LLM might focus on helping to diagnose cardiology related diseases while the other LLM is focusing on gastroenterology.

At step 114, the role-specific response from each LLM is presented to peer LLMs. Throughout the present disclosure, the term “peer LLMs” refers to other LLMs within the multi-model LLMs architecture that work collaboratively alongside the LLMs generating the role-specific response. Notably, the peer LLMs is tasked with its own role and expertise. Moreover, the role-specific responses generated by each LLM is presented to the peer LLMs for further evaluation, ranking, or comparison. The presentation of the role-specific responses to the peer LLMs ensures that the responses generated by each LLM is reviewed by the peer LLMs in the multi-role LLMs architecture and introduces a collaborative and competitive layer in the decision-making process, where multiple LLMs contributes to select the best response by considering various perspectives. Moreover, the peer LLMs evaluate and rank the role-specific responses without being influenced by their own generated responses.

At step 116, a polling process is conducted among the LLMs for ranking the role-specific responses from the LLMs, wherein a given LLM is configured to give a ranking to the role-specific response from the peer LLMs except the role-specific response of said given LLM, wherein the given LLM is configured to provide a justification thought for the ranking of the role-specific responses awarded to the peer LLMs. Throughout the present disclosure, the term “polling process” refers to a structured mechanism of collectively evaluating and ranking the role-specific responses generated by the LLMs within the multi-role LLMs architecture. Notably, during the polling process each LLM reviews and ranks the role-specific responses provided by the peer LLMs based on their respective roles and the context of the user query. Throughout the present disclosure, the term “given LLM” refers to a particular LLM that is being referred at any point to rank the role-specific response from the peer LLMs. Notably, the given LLM ranks only the role-specific responses of the peer LLMs, excluding its own role-specific response to avoid biases. Throughout the present disclosure, the term “justification thought” refers to a reasoning or rationale provided by the given LLM to justify the ranking of the role-specific responses from the peer LLMs in a certain order. Notably, the justification thought reflects criteria, logic or reasoning the given LLM applied when evaluating the role-specific responses from the peer LLMs during the polling process. Moreover, the justification thought offers transparency in the polling process, making the ranking of the role-specific responses clear that why certain role-specific responses were ranked higher or lower based on relevance, accuracy, and the like predefined factors. It will be appreciated that the polling process ensures that all LLMs are involved in decision-making, leading to more balanced and robust outcomes.

In an implementation, the polling process further comprises generating an explanation by each LLM justifying the ranking of the role-specific responses. Herein, the term “explanation” refers to a detailed reasoning or justification provided by each LLM in the multi-role LLMs architecture for the ranking it assigns to role-specific responses. Notably, generation of the explanation is a rationale produced by each LLM to clarify why the said LLM ranked a specific role-specific response in a particular way during the polling process. Moreover, the explanation outlines the reasoning behind the decision and the factors considered in the ranking. Furthermore, each LLM generates the explanation by analysing the content of the role-specific responses from the peer LLMs, considering factors like relevance, accuracy, or alignment with the user's query, context, and previously assigned roles. The explanation is communicated to the other LLMs as part of the polling process. A technical effect of generating an explanation is to verify and understand the rationale of the LLM's choices, ensuring consistency and fairness in role selection and the role-specific response generation.

At step 118, the rankings are aggregated based on the polling process among the LLMs and the relevance score of each of the plurality of roles to determine a final ranking of the role-specific response for each LLM. Herein, the term “final ranking” refers to an ultimate order of ranking or preference assigned to the role-specific responses generated by the LLMs after the polling process. Notably, the final ranking is determined after aggregating the rankings given by each LLM to the role-specific responses of the peer LLMs, based on their relevance and quality, and the relevance score of each of the plurality of roles.

In an implementation, the final ranking is normalized and adjusted with a dynamic weight, wherein the dynamic weight is derived from the relevance score of each role. Herein, the term “dynamic weight” refers to a variable factor that is used to influence the final ranking of role-specific responses generated by each role in the multi-role LLMs architecture. Notably, the dynamic weight is derived from the relevance score of each role, which reflects how pertinent that role is to the current state of the conversation. As each role gain or lose the relevance, the dynamic weight assigned to each role adjusted accordingly. For example, if neurology was added to the role pool initially, but it has not been captured as a potential role in the subsequent flow of the conversation, it's relevance score will decay. Subsequently, the value of the dynamic weight of the said role is reduced. Herein, the term “normalized” refers to a mathematical process that adjust the final ranking values of each role to ensure that each role is on a consistent scale. Notably, the final ranking is normalized in a range of 0 to 1. The normalization of the final ranking allows for fair comparison between the different role-specific responses, as it eliminates discrepancies in scale and magnitude. Moreover, the normalized final ranking is adjusted with the dynamic weight to ensure that highly relevant roles are not discarded due to hallucination in either the next response generation by that specialty or in the ranking phase. This basically ensures that highly relevant roles amongst the plurality of roles within the role pool don't get down rated by the roles with lower relevance score. It will be appreciated that the normalization and adjustment of the final ranking ensures that different ranking scores can be compared fairly, regardless of their original scales or distributions. A technical effect of normalizing and adjusting the final ranking with the dynamic weight is to allow the multi-role LLMs architecture to adapt in real-time to changes in the conversation, ensuring that it remains responsive to user needs and evolving dialogue. Additionally, the aforementioned method ensures that that highly relevant roles are not discarded due to hallucination.

Throughout the present disclosure, the term “aggregating” refers to a process of summing or averaging the rankings given by the LLMs during the polling process and the relevance score of each of the plurality of roles. Typically, the aggregation is performed using a mathematical formula, such as weighted averages or sum of scores, to produce the final ranking. The aggregation is performed on the basis of the relevance score of the plurality of roles and the score coming from the graph representation after normalization to boost or penalise the different specialities. Notably, the aggregated value represents the final ranking of each role-specific response generated by the LLMs. Moreover, purpose of the aggregation is to consolidate the rankings from the polling process and the relevance score into a final determination that reflects the collective evaluation of all LLMs and the contextual importance of each role. Additionally, the aggregation increases the reliability of the method and ground the ranking of the role-specific responses generated in the graphical representation, reduces bias from any single LLM's evaluation, and enhances the overall objectivity of the role-specific response rankings.

At step 120, the role-specific response having a highest final ranking is selected from amongst the final ranking of the role-specific response for each LLM, as an action-inducing response, and transmitting the selected action-inducing response to the user for providing a user action. Herein, the term “highest final ranking” refers to a ranking of the top-ranked or most favourable role-specific response from amongst the final ranking of the role-specific response for each LLM. Notably, the role-specific response having the highest final ranking received the highest cumulative score after the aggregation of the rankings from the polling process and the relevance scores of each role. Throughout the present disclosure, the term “action-inducing response” refers to the role-specific response selected after being ranked highest in the aggregation process that triggers the user to take a specific action or make a decision. Moreover, the selected action-inducing response is sent to the user to prompt the next user action. Throughout the present disclosure, the term “user action” refers to an action performed by the user after receiving the selected action-induced response. Typically, the user action can involve a physical task, an input (like clicking a button or making a selection), verbal confirmation, or performing a task based on the selected action-inducing response transmitted to the user. Furthermore, the action-inducing response (such as the verbal confirmation) can also be a question that the user must answer. For example, if the user input (conversation) is related to headaches and neurology gets the highest ranking, the question may be (1) whether any activity preceded the onset of the headache, or (2) whether there was any physical trauma associated therewith that the user can remember. The goal of the said action is to continue the conversation to gather as much information in the most relevant and efficient way possible. It will be appreciated that the purpose of this step is to ensure that the most relevant, contextually accurate, and actionable response is chosen from among the role-specific responses. Furthermore, the action-inducing response reduces the cognitive load on the user by presenting the most useful information, thereby making the process more efficient and user-friendly.

At step 122, the graph representation is updated based on the action-inducing response and the user action, wherein the updating of the graph representation comprises removing the at least one role having lowest final ranking in a set of previous conversations. Herein, the phrase “set of previous conversations” refers to collection of past interactions or exchanges between the user and the multi-role LLMs architecture, during which the multi-role LLMs architecture processed the queries and provided the role-specific responses. Notably, the set of previous conversations allows the multi-role LLMs architecture to learn from the historical data and progressively optimize the role selection process. Throughout the present disclosure, the term “updating” refers to a process of refining or adjusting the graph representation by removing the at least one role having the lowest ranking in the set of previous conversations. Notably, the updating of the graph representation is based on the action-inducing response and the user action. Moreover, the updating of the graph representation ensures that the multi-role LLMs architecture continuously refines the decision-making process by learning from the set of previous conversations. The at least one role that consistently gets the lowest final ranking is removed from the role pool. For example, specialty like Dermatology is ranked the lowest over 5 turns of the conversation, subsequently, the multi-role LLMs architecture removes Dermatology from the role pool. Advantageously, the removal of the at least one role reduces clutter for the LLMs to generate, and rank and justify in the subsequent turns of the conversation. It is simply a conditional check to see if some role is consistently ranked the lowest and purges that role from the role pool list. Furthermore, purpose of the removal of the at least one role having the lowest final ranking is to have the most appropriate plurality of roles in the role pool and increase the method's ability to generate more relevant and context-aware responses. Optionally, it will be appreciated that the new roles are added to the graph representation if the new roles have a higher final ranking in the set of previous conversations.

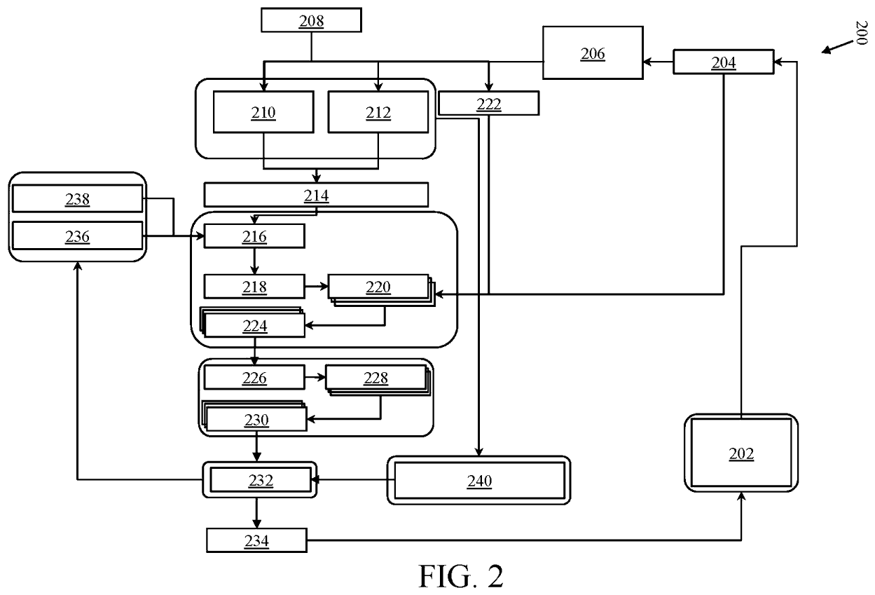

FIG. 2 is flowchart depicting an exemplary scenario depicting steps for distributed decision-making in a multi-role large language models (LLMs) architecture, in accordance with an embodiment of the present disclosure. At step 202, a user query is received for initiating a conversation between a user and the multi-role LLMs architecture. At step 202, the multi-role LLMs architecture initiates the interaction cycle by defining the user's needs and context, which influences the entire decision-making process, including the roles identified and the responses generated. At step 234, the multi-role LLMs architecture closes the loop by providing a tailored response based on that context.

At step 204, conversation context is decided by the multi-role LLMs architecture. The context determined at step 204 influences the design of the role-specific prompts generated at step 220. By understanding the conversation context at step 204, the multi-role LLMs architecture can generate role-specific prompts at step 220 that direct each role to address the specific aspects of the user query. Setting the conversation context at step 204 ensures that the role-specific prompts generated at step 220 are consistent with the user's needs, leading to more relevant responses from each role. Optionally, at step 206, leveraging historical data for generating the graph representation.

At step 208, a graph representation such as domain knowledge graph is used for identifying the plurality of roles, wherein the graph representation comprises a plurality of nodes and links between the plurality of nodes. At step 210, classifying one or more sub-graphs within the graph representation to identify the plurality of roles relevant to the context of the user query. At step 210, the multi-role LLMs architecture identifies potentially relevant roles from the classified sub-graphs. At step 212, traversal network search for a plurality of potential specialties and ranking of the potential specialties. The potentially relevant plurality of roles identified at step 210 are examined and ranked based on their relevance to the user query. The rankings produced at step 210 and 212 contribute to the final ranking determination at step 240. By applying dynamic weights based on these previous evaluations, the multi-role LLMs architecture can ensure that the most pertinent roles are prioritized in the decision-making process. Together, these steps (210, 212 and 240) create a loop of refinement, where the classification of sub-graphs (step 210) leads to focused searches for specialties (step 212), ultimately influencing the way final rankings are calculated and adjusted (step 240) to provide the best possible user responses. At step 214, using at least one graph representation for identifying a plurality of roles and the identified plurality of roles exist in a role pool 216, associated with the user query, wherein the plurality of roles is based on a context of the user query. The plurality of roles selected from the role pool 216 are based on the relevance to the user's query context, which is identified through the graph representation 210 and traversal network search 212.

At step 218, at least one role, from amongst a plurality of identified roles in the role pool 216, is dynamically assigned to the multi-role LLMs architecture. At step 220, a role-specific prompt is generated for each role assumed by each LLM from amongst the multi-role LLMs architecture. The multi-role LLMs architecture uses the plurality of identified roles selected from the role pool 216 to create the role-specific prompt at step 220 for each LLM. The progression from the role selection 214 to the prompt generation 220 ensures that each LLM is well-prepared to address the user query effectively within its designated role.

At step 222, graph RAG retrieves relevant information or context and relationships between different specialties from the graph representation based on the user query or the conversation between the user and the multi-role LLMs architecture. The role-specific prompt generated at step 220 relies heavily on the context and information extracted at step 222. For example, if the Graph RAG identified specific areas of expertise, the role-specific prompts at step 220 can be crafted to ensure that each LLM approaches the query through the lens of its assigned specialty. Moreover, step 222 provides a contextual foundation for step 220 by retrieving essential details and relationships between different specialties from the graph representation. The aforementioned context is crucial in informing the content and structure of the prompts created at Step 220.

At step 224, by each LLM, a role-specific response is generated corresponding to the role-specific prompt for each role and the context of the user query. The role-specific response is generated by each LLM, wherein each LLM uses the role assigned to the multi-role LLMs architecture at step 218, alongside with the role-specific prompt generated in step 220 to craft the role-specific response. Moreover, step 218 is the foundation for step 224, as step 214 identifies roles and step 218 assigns roles based on the query's context. The roles identified at step 214 is crucial for guiding each LLM's response strategy at step 224. Without step 218, step 224 would lack the context-specific roles needed to produce responses aligned with the user's query, leading to generic or less relevant outputs.

At step 226, the generated role-specific response is submitted to a response pool. The response pool serves as the input for the polling process at step 230. At step 228, polling prompts are generated for the polling process. At step 226, multi-role LLMs architecture gathers all the role-specific responses into a single response pool, setting the stage for step 228, where the polling prompts are generated to systematically evaluate the role-specific responses. The role-specific responses pooled at step 226, provides the content needed for the polling, while the polling prompts generated at step 228 provide the structure, guiding each LLM on how to evaluate and rank the role-specific responses effectively.

At step 230, a polling process is conducted among the LLMs for ranking the role-specific responses from the LLMs, wherein a given LLM is configured to give a ranking to the role-specific response from the peer LLMs except the role-specific response of said given LLM. The polling process, without the organized collection of the role-specific response in the response pool (step 226), would lack a cohesive set of options to evaluate. By transitioning from a central response pool to a polling process, the multi-role LLMs architecture enables a peer-review mechanism, where each LLM can critically assess responses based on the expertise or perspective of other roles. The individual rankings generated at step 230 serves as input data for the aggregation of the rankings at step 232. At step 232, the rankings are aggregated based on the polling process among the LLMs and the relevance score of each of the plurality of roles to determine a final ranking of the role-specific response for each LLM. By combining the collective role-specific responses (step 226) with targeted evaluation criteria (step 228), the multi-role LLMs architecture can carry out a balanced ranking process, ensuring that each response is fairly considered and contributes to the final decision. Moreover, without these individual ranking, there would be no basis for calculating the final ranking at step 232. The multi-role LLMs architecture gathers subjective evaluations from each LLM (step 230), while at step 232, the multi-role LLMs architecture combines these perspectives to form a consensus on which response is most suitable, thus facilitating the selection process. Moving from individual LLM assessments to an aggregated ranking, the process synthesizes diverse insights, yielding a prioritized list of responses based on collective intelligence. At step 234, the role-specific response having a highest final ranking is selected from amongst the final ranking of the role-specific response for each LLM, as an action-inducing response and transmitting the selected action-inducing response to the user for providing a user action. The action-inducing response selected at step 234 is directly related to the user query received at step 202. The effectiveness of the response hinges on how well the system understood and processed the original query, thereby reflecting the quality of the initial input. At step 236, role ranking history is measured based on a set of previous conversations. The final ranking from step 232 feeds into step 236, which records and evaluates the role effectiveness over time, creating a historical basis for judging role relevance. The multi-role LLMs architecture at step 236 indicates which roles are underperforming. Moreover, the historical data gathered at step 236 influences the role identification process from the role pool 216. The roles that have consistently performed poorly may be removed from consideration in future queries, thus impacting which roles are selected.

At step 238, the graph representation is updated based on the action-inducing response and the user action, wherein the updating of the graph representation comprises removing the at least one role having lowest final ranking in a set of previous conversations. The multi-role LLMs architecture at step 238 updates the historical role relevance metrics within the multi-role LLMs architecture, based on the input provided at step 236, by flagging the at least one role having lowest final ranking and removing these low-ranking roles from the role pool 216, ensuring that the role pool remains optimized and relevant. Together, the steps 236 and 238 enable the architecture to learn from past interactions, adjusting the available roles and graph structure to maintain high-quality responses in future conversations. Furthermore, the updates made at step 238 lead to changes in the role pool 216 by removing the roles that consistently under perform. As the roles are removed based on their historical performance, the multi-role LLMs architecture can focus on the more relevant and effective roles for responding to the user queries. Optionally, at step 240, the final ranking is normalized and adjusted with a dynamic weight, wherein the dynamic weight is derived from the relevance score of each role.

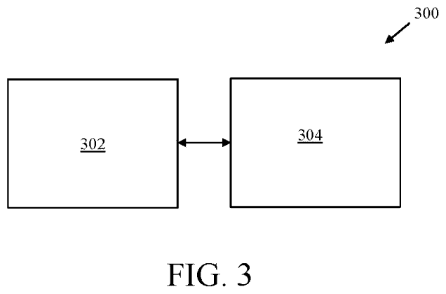

FIG. 3 is schematic implementation of a system 300 for distributed decision-making in a multi-role large language models (LLMs) architecture, in accordance with an embodiment of the present disclosure. As shown in FIG. 3, the system 300 comprises a processor communicably coupled to a user device 304. The processor 302 is configured to receive a receive a user query for initiating a conversation between a user and the multi-role LLMs architecture. Moreover, the processor 302 is configured to use graph representation for identifying a plurality of roles, from a role pool, associated with the user query, wherein the plurality of roles is based on a context of the user query. Optionally the processor 302 is further configured to: generate graph representation based on the conversation between the user and the multi-role LLMs architecture, wherein the graph representation comprises a plurality of nodes and links between the plurality of nodes; and classify one or more sub-graphs within the graph representation to identify the plurality of roles relevant to the context of the user query. Furthermore, the processor 302 is configured to assign a relevance score to each of the plurality of roles, wherein the relevance score is assigned based on the context of the user query. Furthermore, the processor 302 is configured to dynamically assign the at least one role, from amongst a plurality of roles, having a relevance score higher than a predetermined relevance score threshold, to the multi-role LLMs architecture. Furthermore, the processor 302 is configured to generate, by each LLM, a role-specific response corresponding to the role-specific prompt for each role and the context of the user query. Furthermore, the processor 302 is configured to present the role-specific response from each LLM to peer LLMs. Furthermore, the processor 302 is configured to conduct a polling process among the LLMs for ranking the role-specific responses from the LLMs, wherein a given LLM is configured to give a ranking to the role-specific response from the peer LLMs except the role-specific response of said given LLM. Furthermore, the processor 302 is configured to aggregate the rankings based on the polling process among the LLMs and the relevance score of each of the plurality of roles to determine a final ranking of the role-specific response for each LLM. Furthermore, the processor 302 is configured to select the role-specific response having a highest final ranking, from amongst the final ranking of the role-specific response for each LLM, as an action-inducing response, and transmitting the selected action-inducing response to the user for providing a user action. Furthermore, the processor 302 is configured to update the graph representation based on the action-inducing response and the user action, wherein the updating of the graph representation comprises removing the at least one role having lowest final ranking in a set of previous conversations.

Herein, the term processor 302 refers to a computational element that is operable to execute the software framework. Examples of the processor 302 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor 302 may refer to one or more individual processors, processing devices and various elements associated with a processing device that may be shared by other processing devices. Additionally, one or more individual processors, processing devices and elements are arranged in various architectures for responding to and processing the instructions that execute the software framework.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for distributed decision-making in a multi-role large language models (LLMs) architecture, the method comprising:
receiving a user query for initiating a conversation between a user and the multi-role LLMs architecture;
using a graph representation for identifying a plurality of roles, from a role pool, associated with the user query, wherein the plurality of roles is based on a context of the user query;
assigning a relevance score to each of the plurality of roles, wherein the relevance score is assigned based on the context of the user query;
dynamically assigning at least one role, from amongst the plurality of roles, to the multi-role LLMs architecture;
generating a role-specific prompt for each role assumed by each LLM from amongst the multi-role LLMs architecture;
generating, by each LLM, a role-specific response corresponding to the role-specific prompt for each role and the context of the user query;
presenting the role-specific response from each LLM to peer LLMs;
conducting a polling process among the LLMs for ranking the role-specific responses from the LLMs, wherein a given LLM is configured to give a ranking to the role-specific response from the peer LLMs except the role-specific response of said given LLM;
aggregating the rankings based on the polling process among the LLMs and the relevance score of each of the plurality of roles to determine a final ranking of the role-specific response for each LLM;
selecting the role-specific response having a highest final ranking, from amongst the final ranking of the role-specific response for each LLM, as an action-inducing response, and transmitting the selected action-inducing response to the user for providing a user action; and
updating the graph representation based on the action-inducing response and the user action, wherein the updating of the graph representation comprises removing the at least one role having lowest final ranking in a set of previous conversations.

2. The method of claim 1, further comprising:
generating the graph representation based on the conversation between the user and the multi-role LLMs architecture, wherein the graph representation comprises a plurality of nodes and links between the plurality of nodes; and
classifying one or more sub-graphs within the graph representation to identify the plurality of roles relevant to the context of the user query.

3. The method of claim 2, further comprising calculating a cosine distance between the plurality of nodes of the graph representation of the user.

4. The method of claim 1, wherein the polling process further comprises generating an explanation by each LLM justifying the ranking of the role-specific responses.

5. The method of claim 1, wherein the final ranking is normalized and adjusted with a dynamic weight, wherein the dynamic weight is derived from the relevance score of each role.

6. The method of claim 2, wherein the method further comprises calculating an n-hop distance between one or more new nodes and the plurality of nodes, and wherein the n-hop distance for the one or more new nodes are averaged over the plurality of nodes to determine a traversal network score.

7. The method of claim 2, wherein the role pool consists of plurality of potential specialties represented by the plurality of nodes in the traversal network, wherein the plurality of potential specialties is selected based on the relevance score.

8. The method of claim 2, further comprising leveraging historical data for generating the graph representation.

9. The method of claim 2, wherein the at least one role, from amongst the plurality of roles, having a relevance score higher than a predetermined relevance score threshold, is dynamically assigned to the multi-role LLMs architecture.

10. A system for distributed decision-making in a multi-role large language models (LLMs) architecture, the system comprising a processor communicably coupled to a user device, the processor configured to:
receive a user query for initiating a conversation between a user and the multi-role LLMs architecture;
use a graph representation for identifying a plurality of roles, from a role pool, associated with the user query, wherein the plurality of roles is based on a context of the user query;
assign a relevance score to each of the plurality of roles, wherein the relevance score is assigned based on the context of the user query;
dynamically assign at least one role, from amongst the plurality of roles, to the multi-role LLMs architecture;
generate a role-specific prompt for each role assumed by each LLM from amongst the multi-role LLMs architecture;
generate, by each LLM, a role-specific response corresponding to the role-specific prompt for each role and the context of the user query;
present the role-specific response from each LLM to peer LLMs;
conduct a polling process among the LLMs for ranking the role-specific responses from the LLMs, wherein a given LLM is configured to give a ranking to the role-specific response from the peer LLMs except the role-specific response of said given LLM;
aggregate the rankings based on the polling process among the LLMs and the relevance score of each of the plurality of roles to determine a final ranking of the role-specific response for each LLM;
select the role-specific response having a highest final ranking, from amongst the final ranking of the role-specific response for each LLM, as an action-inducing response, and transmitting the selected action-inducing response to the user for providing a user action; and
update the graph representation based on the action-inducing response and the user action, wherein the updating of the graph representation comprises removing the at least one role having lowest final ranking in a set of previous conversations.

11. The system of claim 10, wherein the processor is further configured to:
generate the graph representation based on the conversation between the user and the multi-role LLMs architecture, wherein the graph representation comprises a plurality of nodes and links between the plurality of nodes; and
classify one or more sub-graphs within the graph representation to identify the plurality of roles relevant to the context of the user query.

12. The system of claim 11, wherein the processor is further configured to calculate a cosine distance between the plurality of nodes of the graph representation of the user.

13. The system of claim 10, wherein the processor is further configured to generate an explanation by each LLM justifying the ranking of the role-specific responses.

14. The system of claim 10, wherein the processor is further configured to normalize the final ranking and adjust the normalized final ranking with a dynamic weight, wherein the dynamic weight is derived from the relevance score of each role.

15. The system of claim 11, wherein the processor is further configured to calculate an n-hop distance between one or more new nodes and the plurality of nodes, and wherein the n-hop distance for the one or more new nodes are averaged over the plurality of nodes to determine a traversal network score.

16. The system of claim 11, wherein the role pool consists of plurality of potential specialties represented by the plurality of nodes in the traversal network, wherein the plurality of potential specialties is selected based on the relevance score.

17. The system of claim 11, wherein the processor is further configured to leverage historical data for generating the graph representation.

18. The system of claim 11, wherein the processor is further configured to dynamically pass the plurality of roles, having a relevance score higher than a predetermined relevance score threshold, to the multi-role LLMs architecture;

19. A non-transitory computer-readable storage medium having computer-readable instructions stored thereon, the computer-readable instructions being executable by a processor to execute a method of claim 1.
